(19) United States
(12) Patent Application Publication
(10) Pub. No.: US 2019/0389455 A1
(43) Pub. Date: Dec. 26, 2019

(54) BLENDED AUTONOMOUS DRIVING SYSTEM

(71) Applicant: INTERNATIONAL BUSINESS MACHINES CORPORATION, Armonk, NY (US)

(72) Inventor: Thomas C. Reed, Tucson, AZ (US)

(21) Appl. No.: 16/016,969

(22) Filed: Jun. 25, 2018

(51) Int. Cl. B60W 30/09; G06K 9/00; B60W 40/08; B60W 50/14; G05D 1/00

(52) U.S. Cl. CPC B60W 30/09; G06K 9/00845; B60W 40/08; B60W 50/14; G06K 9/00805; G06K 9/00798; G05D 2201/0213; B60W 2040/0818; B60W 2540/26; B60W 2550/10; B60W 2050/143; B60W 2540/28; B60W 2040/0809; G05D 1/0088

(57) ABSTRACT

Methods, systems, and computer program products for blended autonomous driving are presented. Aspects include receiving vehicle environment data associated with a vehicle. Driver data associated with a driver of the vehicle is received and analyzed to determine a driver alertness level. The vehicle environment data is analyzed to identify a potential event and a first action for the potential event is initiated based on a determination that the driver alertness level is below a threshold.

### BACKGROUND

The present invention generally relates to an autonomous driving system, and more specifically, to a blended autonomous driving system.

Driver assistance systems are systems to help a driver of a vehicle in the driving process. Typically, the driver assist systems are developed to automate, adapt, and enhance a vehicle system for safety and better driving. Some example assistance systems include enhancements such as electronic stability control, anti-locking brakes, lane departure warnings and alerts, adaptive cruise control, and vehicle traction control. While helpful in assisting drivers with operating a vehicle, these systems can sometimes cause a driver to be complacent leading the driver to completely rely on these systems in lieu of utilizing their own judgment. Also, having too many alerts or too much assistance can cause a driver to ignore the system and/or turn off the driver assist systems.

### SUMMARY

Embodiments of the present invention are directed to a computer-implemented method for blended autonomous driving. A non-limiting example of the computer-implemented method includes receiving vehicle environment data associated with a vehicle. Driver data associated with a driver of the vehicle is received and analyzed to determine a driver alertness level. The vehicle environment data is analyzed to identify a potential event and a first action for the potential event is initiated based on a determination that the driver alertness level is below a threshold.

Embodiments of the present invention are directed to a system for blended autonomous driving. A non-limiting example of the system includes receiving vehicle environment data associated with a vehicle. Driver data associated with a driver of the vehicle is received and analyzed to determine a driver alertness level. The vehicle environment data is analyzed to identify a potential event and a first action for the potential event is initiated based on a determination that the driver alertness level is below a threshold.

Embodiments of the invention are directed to a computer program product for blended autonomous driving, the computer program product comprising a computer readable storage medium having program instructions embodied therewith. The program instructions are executable by a processor to cause the processor to perform a method. A non-limiting example of the method includes receiving vehicle environment data associated with a vehicle. Driver data associated with a driver of the vehicle is received and analyzed to determine a driver alertness level. The vehicle environment data is analyzed to identify a potential event and a first action for the potential event is initiated based on a determination that the driver alertness level is below a threshold.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a computer system for use in implementing one or more embodiments of the present invention;

FIG. 2 depicts a block diagram of a system for blended autonomous driving according to embodiments of the invention; and

FIG. 3 depicts a flow diagram of a method for blended autonomous driving according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

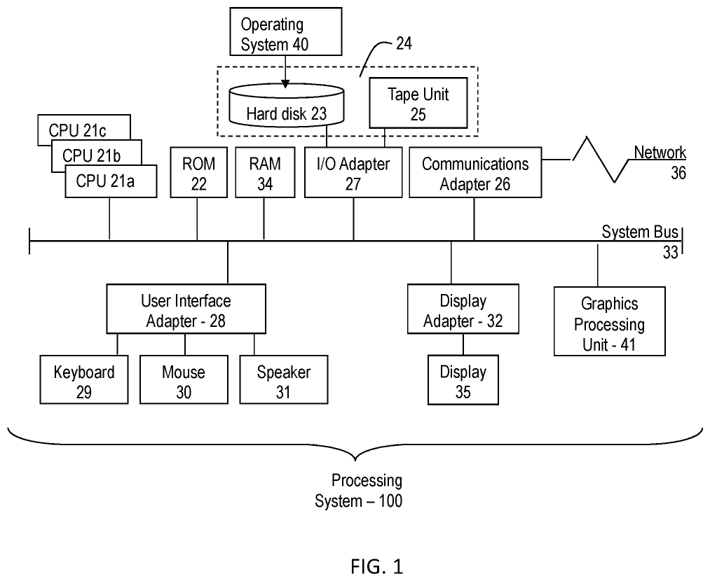

Referring to FIG. 1, there is shown an embodiment of a processing system 100 for implementing the teachings herein. In this embodiment, the system 100 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 100.

FIG. 1 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 100 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 100 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 1. The processing system 100 described herein is merely exemplary and not intended to limit the application, uses, and/or technical scope of the present invention. FIG. 1 is merely a non-limiting example presented for illustrative and explanatory purposes.

Turning now to an overview of technologies that are more specifically relevant to aspects of the invention, driver assist technologies attempt to assist drivers with avoiding common road accidents typically caused by human error. Currently, driver assistance systems fail to account for the actual attention and intention of a driver of a vehicle. Because of these systems fail to account for attention and intention of the driver, the systems can potentially be intrusive and distracting to a driver when the system activates in a manner that is redundant to the driver's active attention. This may lead to a driver ignoring and/or turning off the driver assist system in their vehicle. Also, the converse may occur were driver assist systems fail to adequately account for a driver's complacency incurred by reliance on the drive assist and/or on the driver's ability to intervene should the driver assist require such intervention. For example, a driver may be completely dependent on the driver assist system and fail to “double check” when operating the vehicle in a potentially hazardous manner such as changing lanes without looking.

Turning now to an overview of the aspects of the invention, one or more embodiments of the invention address the above-described shortcomings of the prior art by providing a system to redefine the relationship between the driver of a vehicle and the driver assist system. This relationship can scale from minor driver assistance up to fully autonomous driving in real time based on driver attention. Aspects of the invention include an autonomous driving system for a vehicle and a driving gaze detection camera system in the vehicle to detect and determine the focus and attention of a driver of the vehicle.

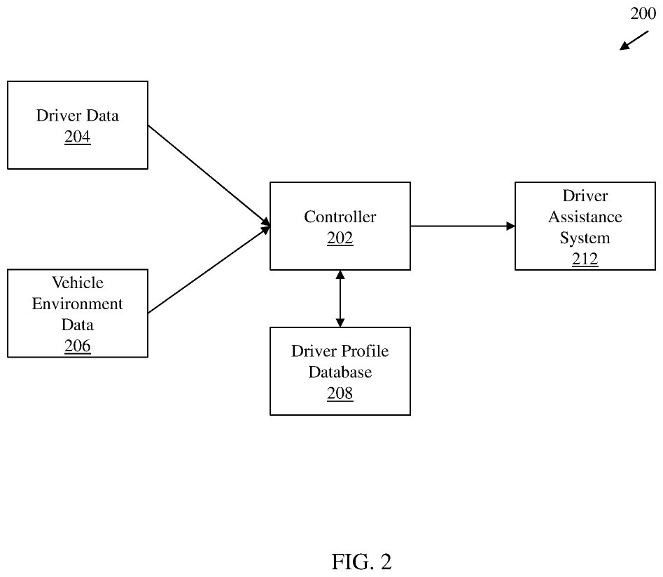

Turning now to a more detailed description of aspects of the present invention, FIG. 2 depicts a block diagram of a system 200 for blended autonomous driving according to embodiments of the invention. The system 200 includes a controller 202, a driver assistance system 212, and a driver profile database 208. The controller 202 can receives driver data 204 and vehicle environment data 206. The driver data 204 can be collected from a gaze tracking camera in communication with the controller 202. The controller 202 communicates with the driver assistance system 212. In one or more embodiments of the invention, the driver assistance system 212 can be a society of automotive engineers (SAE) level 3 or level 4 autonomous driving system.

In one or more embodiments, the controller 202 can be implemented on the processing system 100 found in FIG. 1. Additionally, a cloud computing system can be in wired or wireless electronic communication with one or all of the elements of the system 100. Cloud computing can supplement, support or replace some or all of the functionality of the elements of the system 100.

In one or more embodiments, the vehicle environment data 206 can be collected from sensors on or around a vehicle. Any type of sensor can be used to collect the vehicle environmental data 206 including, but not limited to, cameras, LIDAR, sonar sensor, Doppler effect sensors, and the like. In one or more embodiments of the invention, the driver assistance system 212 can control the sensors and communicate the vehicle environment data 206 to the controller. In one or more embodiments of the invention, the controller 202 receives the vehicle environment data 206 and creates an integrated information layer that represents the driving related environment surrounding the vehicle. This layer can be referred to as the autonomous driving layer (ADL). The driver data 204 can be collected from sensors including cameras that detect and track a driver's gaze. In one or more embodiments of the invention, an array of cameras can be utilized to determine the direction of the driver's gaze, the three dimensional (3D) positioning of the driver's eyes within the cabin of the vehicle, and any obstructions to the driver's gaze in the plane of the windshield of the vehicle. From this driver data 204, the controller 202 can calculate an ideal vision cone for the driver and subtracts obstructions allowing for an estimate of the driver's awareness (alertness). This vision cone subtracting out obstructions can be referred to as the driver awareness level (DAL).

In one or more embodiments of the invention, by taking a geometric intersection of the autonomous driving layer (e.g., vehicle environment data 206) and the vision cone for the driving in the driver awareness level, the controller 202 can generate vehicle referenced patch containing a subset of entities which both the driver assistance system 212 and the human driver are likely aware of. For example, the vehicle environment data 206 might show a stop sign in front of the vehicle. By intersecting the driver's vision cone (taken from the gaze detection) with the vehicle environment data 206, the controller 202 can determine that the driver is aware of the stop sign as it is in the driver's field of vision.

In one or more embodiments, the driver awareness (alertness) to a potential event (e.g., hazard, traffic sign, etc.) can be categorized into three levels. The first level is an aware level where the driver is looking directly at the potential event and attending to it. For example, a car in front of the vehicle has stopped and the driver is looking at the care and decelerating the vehicle in anticipation of the stopped car. The second level is the peripheral awareness level where the potential event is likely in the driver's peripheral vision but the drive might not be directly attending to it. For example, a car on a highway has changed lanes next to the driver's vehicle. The third level is the unaware level where the potential event is out of the driver's potential site line according to gaze detection (e.g., driver data 204). These three levels can be considered by the controller 202 when determining an action to be taken in response to the potential event. In one or more embodiments, the controller 202 can engage the driver assistance system 212 to perform an action in response to detection of a potential event and the level of awareness (alertness) of the driver. The three levels of driver awareness can exist on a continuum and can be modified by time. For example, the driver assistance system 212 would not necessarily perform an action in response to a potential event every time a driver blinks. However, the driver assistance system 212 could gradually assume control of the vehicle if the driver's eyes were closed for a longer period of time. Intersecting the ADL with the DAL allows the controller 202 to generate a heat map of driver awareness (i.e., an Awareness Map).

In one or more embodiments of the invention, the system 200 connects the awareness of the driver and the awareness of the driver assistance system 212 to enable advanced behaviors by blending the intervention of the driver assistance system 212. The driver assistance system 212 can have multiple combined systems such as, for example, a 360 degree obstacle detection, long range forward object detection, lane detection and lane keeping, adaptive cruise control, emergency braking assistance, blind spot assistance, and the like. The sensing systems can collect the vehicle environment data 206 and communicate this data to the controller 202. The intervention systems can be utilized when initiating an action in response to a potential event.

In one or more embodiments of the invention, these intervention systems in the driver assistance system 212 share traits of intervention thresholds and intervention strength. Intervention thresholds refer to a threshold that determines when and if an intervention is taken by the driver assistance system 212. The invention strength can refer to the level of intervention taken by the driver assistance system. For example, a strong intervention could be an application of a brake or taking control of the vehicle steering in response to a potential event. A weak intervention could be generating an alert for the driver in response to a potential event. In one or more embodiments of the invention, the intervention thresholds and intervention strength can be modified based on the driver awareness determined from the driver data 204 (e.g., gaze detection, etc.). In some embodiments, the system 200 can presume a driver intends to take the actions that they are taking when the driver awareness is high. For example, if a driver is alert and his or her vision, as determined by the driver data 204, is focused on the road, the driver can switch lanes on a highway without the controller 202 engaging the driver assistance system 212 to intervene with lane detection and lane keeping. The system 200 can presume the driver intends to leave the lane based on the driver's awareness. However, should the driver's awareness level be lower (e.g., driver focus is elsewhere), then leaving a traffic lane can trigger the lane detection and lane keeping to perform an action (i.e., intervene). The intervention strength can be determined by the controller 202 based on the vehicle environment data 206. For example, if the driver's awareness is low and the vehicle is leaving a traffic lane and moving into a lane occupied by another car, the intervention can be strong such as, for example, taking control of the steering.

In one or more embodiments of the invention, when a driver's attention is focused somewhere other than the road, the intervention threshold and strength can be reduced. This allows for more generally safe behaviors such as assisting with lane keeping or following distance when the driver looks over their shoulder or out a side window, for example. In one or more embodiments, the strength of an action can be reduced to prevent emergency situations. Emergency interventions can impact other drivers who may not have the benefit of a driver assistance system. Resorting to emergency intervention is undesirable as it creates a more dangerous situation for surrounding vehicles. Emergency intervention can result in a situation where surrounding vehicles might in turn have to react quickly to avoid an incident. An example would be an emergency braking event. The emergency braking can create a situation where the following vehicle must react quickly and correctly to also avoid a collision. Emergency braking for other drivers might not be possible as the following driver could be following too closely, be distracted, or in the case of a large truck, not physically be able to stop in time to avoid the collision. Anticipating situations which, left unchecked, can result in the need for an emergency intervention and instead intervening earlier and with less intensity, when the driver is distracted or otherwise does not intervene, allows surrounding traffic more time to react and increases the safety of everyone on the road. For example, the assisted driver is approaching an intersection where the light is red and there is a car stopped at the light directly ahead. The assisted driver is distracted, looking at the radio or in the back seat at their children. Conventional systems would wait until the last moment to intervene whereas the system 200 would intervene gently much sooner because the driver is distracted. For example, while a conventional system may wait until a detected impending collision to apply a break, the current system can first sound a warning chime to refocus the driver, then gently pump the breaks to get the drivers attention if the chime was unsuccessful, and only apply a hard stop break at the last minute to avoid the collision. The result is a safer situation for all traffic involved.

In one or more embodiments of the invention, the system 200 can learn the driving behavior of specific drivers for a vehicle and store these driving behaviors in a driver profile. The driver profile can be stored the driver profile database 208 and can be accessed by the controller 202 when the driver is operating the vehicle. The intervention thresholds for the system 200 can be initially set by industry standards or be proprietary to the driver assistance system 212. In one or more embodiments of the invention, the system 200 collects driver data 204 and can update the intervention thresholds based on the historical driving behaviors stored in the driver profile. As the intervention thresholds are updated, these thresholds can be stored in the driver profile and utilized each time the driver operates the vehicle.

In one or more embodiments of the invention, the driver data 204 can include facial recognition data. The controller 202 can analyze the facial recognition data to determine the identity of the driver. Once the identity is determined, the controller 202 can access the driver profile from the driver profile database 208. As described above, the driver profile includes historic driving behavior, preferences, and intervention thresholds and strengths. Some drivers prefer to drive more aggressively and the intervention thresholds can be lowered based on the driver's more aggressive driving behavior, for example. In one or more embodiments, the driver profile database 208 can be housed in the system 200 in the vehicle or can be a cloud databased accessed through a network such as, for example, a cellular network. In some embodiments, a driver profile can be stored on a driver's smart phone and accessed by the controller 202 when the smartphone pairs with the vehicle through a wired or wireless connection.

In one or more embodiments, the vehicle environment data 206 can include additional data collected by the controller 202 accessing outside systems such as, for example, weather systems, traffic systems, and the like. The traffic conditions for the vehicle can be taken in to account when determining intervention thresholds and intervention strengths. For example, in heavy traffic, the intervention threshold may be increased to account for the potential of hazardous events (e.g., obstructions, vehicles changing lanes, etc.).

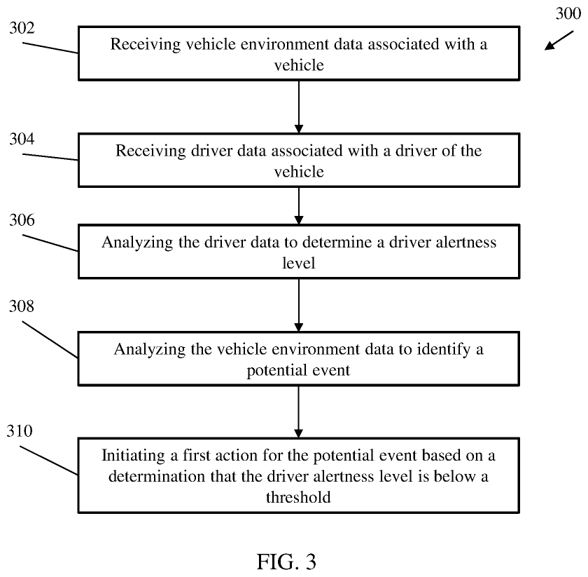

FIG. 3 depicts a flow diagram of a method for blended autonomous driving according to one or more embodiments of the invention. The method 300 includes receiving vehicle environment data associated with a vehicle, as shown in block 302. At block 304, the method 300 includes receiving driver data associated with a driver of the vehicle. The driving data can include sensor data about the driver to determine driver awareness or alertness based on eye tracking and other indicators. At block 306, the method 300 includes analyzing the driver data to determine a driver alertness level. The method 300, at block 308, includes analyzing the vehicle environment data to identify a potential event. And at block 310, the method 300 includes initiating a first action for the potential event based on a determination that the driver alertness level is below a threshold. Potential events include driving obstructions, a determination of an unsafe driving condition, and other driving events such as pedestrian crossings, traffic lights and traffic signs, etc. The first action can be any action including the operating of the vehicle to avoid the potential event and/or generating alerts for a driver to draw attention to the potential event.

Additional processes may also be included. It should be understood that the processes depicted in FIG. 3 represent illustrations, and that other processes may be added or existing processes may be removed, modified, or rearranged without departing from the scope and spirit of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for blended autonomous driving, the method comprising:
receiving vehicle environment data associated with a vehicle;
receiving driver data associated with a driver of the vehicle;
analyzing the driver data to determine a driver alertness level;
analyzing the vehicle environment data to identify a potential event; and
initiating a first action for the potential event based on a determination that the driver alertness level is below a threshold.

2. The computer-implemented method of claim 1 further comprising initiating a second action for the potential event based on a determination that the driver alertness level is above the threshold.

3. The computer-implemented method of claim 2, wherein the second action comprises generating an alert associated with the potential event for the driver.

4. The computer-implemented method of claim 1, wherein the vehicle environment data comprises at least one of object detection, lane detection, and blind spot detection.

5. The computer-implemented method of claim 1, wherein the driver data comprises gaze tracking data for the driver; and
wherein determining the driver alertness level comprises:
analyzing the gaze tracking data associated with the driver;
generating a driver vision map based at least in part on the gaze tracking data; and
comparing the driver vision map with the vehicle environmental data to determine the driver alertness level.

6. The computer-implemented method of claim 1, wherein the first action comprises applying a brake for the vehicle to avoid the potential event.

7. The computer-implemented method of claim 1, wherein the potential event comprises a potential hazard for the vehicle.

8. The computer-implemented method of claim 1, wherein the driver data further comprises driving behavior for the driver; and the method further comprises:
storing the driving behavior for the driver in a driver profile associated with the driver.

9. The computer-implemented method of claim 8 further comprising adjusting the threshold based on the driver profile.

10. The computer-implemented method of claim 8 further comprising:
capturing, by a sensor, one or more images of the driver;
determining an identity of the driver based at least in part on the one or more images of the driver;
accessing the driver profile associated with the driver based on the identity of the driver; and
adjusting the threshold based on the driver profile.

11. A system for blended autonomous driving, the system comprising:
a processor communicatively coupled to a memory, the process configured to:
receive vehicle environment data associated with a vehicle;
receive driver data associated with a driver of the vehicle;
analyze the driver data to determine a driver alertness level;
analyze the vehicle environment data to identify a potential event; and
initiate a first action for the potential event based on a determination that the driver alertness level is below a threshold.

12. The system of claim 11, wherein the processor is further configured to initiate a second action for the potential event based on a determination that the driver alertness level is above the threshold.

13. The system of claim 11, wherein the vehicle environment data comprises at least one of object detection, lane detection, and blind spot detection.

14. The system of claim 11, wherein the driver data comprises gaze tracking data for the driver; and
wherein determining the driver alertness level comprises:
analyzing, by the processor, the gaze tracking data associated with the driver;
generating a driver vision map based at least in part on the gaze tracking data; and
comparing the driver vision map with the vehicle environmental data to determine the driver alertness level.

15. The system of claim 11, wherein the first action comprises applying a brake for the vehicle to avoid the potential event.

16. A computer program product for blended autonomous driving, the computer program product comprising a computer readable storage medium having program instructions embodied therewith, wherein the computer readable storage medium is not a transitory signal per se, the program instructions executable by a processor to cause the processor to perform a method comprising:
receiving vehicle environment data associated with a vehicle;
receiving driver data associated with a driver of the vehicle;
analyzing the driver data to determine a driver alertness level;
analyzing the vehicle environment data to identify a potential event; and
initiating a first action for the potential event based on a determination that the driver alertness level is below a threshold.

17. The computer program product of claim 16 further comprising initiating a second action for the potential event based on a determination that the driver alertness level is above the threshold.

18. The computer program product of claim 16, wherein the vehicle environment data comprises at least one of object detection, lane detection, and blind spot detection.

19. The computer program product of claim 16, wherein the driver data comprises gaze tracking data for the driver; and
wherein determining the driver alertness level comprises:
analyzing the gaze tracking data associated with the driver;
generating a driver vision map based at least in part on the gaze tracking data; and
comparing the driver vision map with the vehicle environmental data to determine the driver alertness level.

20. The computer program product of claim 16, wherein the first action comprises applying a brake for the vehicle to avoid the potential event.
